(19) United States
(12) Patent Application Publication
(10) Pub. No.: US 2021/0052995 A1
(43) Pub. Date: Feb. 25, 2021

(54) DEVICE AND METHOD FOR FILTERING A FLUID CIRCULATING IN A PLUMBING AND HEATING SYSTEM

(71) Applicant: I.V.A.R. S.P.A., Prevalle (BS) (IT)

(72) Inventor: Umberto BERTOLOTTI, Prevalle (BS) (IT)

(73) Assignee: I.V.A.R. S.P.A., Prevalle (BS) (IT)

(21) Appl. No.: 16/967,904

(22) PCT Filed: Feb. 6, 2019
(86) PCT No.: PCT/IB2019/050952

§ 371 Date: Aug. 6, 2020

(30) Foreign Application Priority Data
Feb. 14, 2018 (IT) 102018000002685

(51) Int. Cl. B01D 29/35; B01D 29/90; B01D 29/92; B01D 35/06; C02F 1/00; C02F 1/48; F24D 19/10

(52) U.S. Cl. CPC B01D 29/35; B01D 29/902; B01D 29/925; B01D 2201/302; C02F 1/001; C02F 1/481; F24D 19/1006; B01D 35/06

(57) ABSTRACT

The present invention relates to a device (1) for filtering a fluid circulating in a plumbing and heating system, said device comprising a body (2) which defines therewithin a filtration chamber (3) that is intended to have a fluid to be subjected to filtration pass through it. The body is provided with a first inlet/outlet opening (10), a second inlet/outlet opening (20) and a third inlet/outlet opening (30): each one of them sets the filtration chamber (3) in communication with the outside of the device and is associable with a line of the system so as to receive therefrom, or to send thereto, fluid entering, or exiting from, said body of the device. The device operates a passage of fluid through the filtration chamber (3), in a selective manner according to a plurality of operative configurations, from one opening among said first inlet/outlet opening (10), second inlet/outlet opening (20) and third inlet/outlet opening (30) to another opening among said first inlet/outlet opening (10), second inlet/outlet opening (20) and third inlet/outlet opening (30). The device further comprises: filtering members (40) that are housed inside the filtration chamber (3) and operatively interposed between the inlet/outlet openings to carry out filtering of the fluid passing through the filtration chamber; a flow-directing insert (70) that is housed inside the filtration chamber (3) and configured to channel the fluid passing through the filtration chamber, in each one of the operative configurations, so that the fluid passes at least partially through the filtering members (40).

The present invention relates to a device, and an associated method, for filtering a fluid circulating in a plumbing and heating system

The invention has advantageous application in the context of plumbing systems for temperature regulation and/or the supply of domestic hot water in residential, commercial or industrial buildings.

Heating or domestic hot water supply systems provide for the circulation of a fluid, typically water, which circulates through the various system components (pipes, boiler, pump, valves, radiant elements, utilities, etc.).

In such systems the use of filters suitable for maintaining the circulating fluid as clean as possible, i.e. free of impurities, such as dirt, sand, polluting particles, etc., is well known. This is because such impurities, while circulating within the system, can provoke clogging, faults in some components, in particular the boiler and the valves, and in general cause a deterioration in the performance of the various components and a loss of overall efficiency.

Among the various impurities, it is particularly important to remove the ferrous particles—typically released by system components such as pipes and radiant elements (for example heaters and radiators)—since they can cause breaks inside the boiler members or perforations in the pipes of the system.

The filters are usually installed interposed between the line carrying the fluid returning from the system, typically containing impurities and ferrous particles, and the line that sends the incoming fluid to the boiler (or heat pump). In this manner, the filter can act on the delivery to the boiler, that is, upstream of the latter, by sending fluid that has been filtered and cleaned of impurities.

Because of this typical installation, the known filters are usually identified as “under-boiler” filters; moreover, in the jargon of this technical sector, such filters are called “dirt separators”, because of their function of removing impurities.

Providing that the filter may be opened in order to carry out periodic maintenance operations, and in particular to remove the impurities collected by the filter or replace the filtering elements, is likewise known.

One known type of filter provides both for the use of mesh filtering elements, which retain impurities such as sand and dirt, and the use of filtering elements of a magnetic type, which enable the ferrous particles to be separated from the fluid in transit by attracting them and holding them in contact with the magnetic element.

An example of a mechanic magnetic filter is described in European patent application EP3159313A1. This solution envisages a filter body provided with three distinct inlet/outlet mouths, identical to one another, two of which lateral, in opposite positions of the body, and an upper one; essentially, the three mouths are arranged like a “T”. At the time of installation, it is possible to select which of the three mouths will be connected to the return line of the system and which must instead be connected to the line delivering to the boiler. This allows the filter to be installed vertically or horizontally, based on the space available beneath the boiler (which in some cases is very limited) and the position of the wall the boiler is fixed to, by appropriately connecting the mouths.

The Applicant has found that the prior art solutions described above are not without drawbacks and could be improved in several respects.

First of all, the known solutions provided with three mouths arranged like a “T” are capable of filtering effectively only when the central mouth, i.e. the one situated on top of the filter body, is used for the entry of fluid into the filter or for the exit of fluid from the filter. This is because the known solutions envisage a cylindrical mesh filtering element (mechanical filtering) disposed longitudinally inside the filtration chamber, for the entire length of the chamber itself, and a magnetic filtering element disposed, in turn, inside the cylindrical mesh element. In this configuration, the central mouth (situated on top of the body of the cylinder) is inside the cylindrical mesh element, whereas the two lateral mouths (on opposite sides of the body of the cylinder) are instead outside the cylindrical mesh element.

This means, in particular in configurations in which the two lateral mouths are used for the entry of the fluid to be filtered and the exit of the filtered fluid (and the upper mouth is capped), that the flow can easily travel through the filtration chamber, passing around the cylindrical mesh element, without being obliged to pass through it, and as a result most of the fluid passes through the filter without being subjected to mechanical filtering (i.e. without passing through the mesh), with a consequent reduced filtering of impurities and dirt, and without flowing in proximity to the magnetic element, with a consequent reduced filtering of the ferrous particles.

In short, although some of the known solutions are proposed for a use according to various configurations, intended to meet different installation needs, they operate efficiently in one configuration only, whereas in other configurations there is no passage of the entire flow through the filtering elements, only a simple transit from the inlet mouth to the outlet mouth.

In addition, the known solutions pose a risk of clogging of the cylindrical mesh element that performs the mechanical filtering, because of the non-optimal management of the flows circulating inside the filtration chamber. Clogging introduces a decrease in the rate of flow through the filter, or even complete obstruction.

Furthermore, the known filters are not able to provide effective solutions, in terms of assembly, access and maintenance, for all the different installation conditions and the different types of boilers, heat exchangers or heat pumps.

In this situation the object at the basis of the present invention, in the various aspects and/or embodiments thereof, is to provide a device and a method for filtering a fluid that may be capable of remedying one or more of the above-mentioned drawbacks.

A further object of the present invention is to provide a device and a method capable of achieving an effective filtration of a fluid circulating in a plumbing and heating system.

A further object of the present invention is to provide a device for filtering a fluid that is characterised by great versatility and is capable of being adapted to a high number and different types of boilers or other components of a heating system.

A further object of the present invention is to provide a device for filtering a fluid capable of operating with consistent high performances irrespective of the mode of installation inside a plumbing and heating system.

A further object of the present invention is to provide a device for filtering a fluid characterised by a high operating reliability and/or a lower predisposition to faults and malfunctions and/or which is capable of being maintained in a simple and rapid manner.

A further object of the present invention is to provide a device for filtering a fluid characterised by a simple and rational structure.

A further object of the present invention is to provide a device for filtering a fluid characterised by a low production cost in relation to the performances and quality offered.

A further object of the present invention is to create alternative solutions to the prior art in the construction of devices and methods for filtering a fluid circulating in a plumbing and heating system, and/or to open new fields of design.

These objects, and any others that will become more apparent in the course of the following description, are substantially achieved by a device for filtering a fluid and a method for filtering a fluid according to one or more of the appended claims, each of which taken on its own (without the related dependencies) or in any combination with the other claims, as well as according to the following aspects and/or embodiments, differently combined, also with the aforesaid claims.

In a first aspect thereof, the invention relates to a device for filtering a fluid, comprising a body of the device which defines therewithin a filtration chamber that is intended to have a fluid to be subjected to filtration pass through it, said body being provided with:
a first inlet/outlet opening, which sets said filtration chamber in communication with the outside of the device and is configured to be associated with a line so as to receive therefrom, or to send thereto, fluid entering, or exiting from, said body of the device;
a second inlet/outlet opening, which sets said filtration chamber in communication with the outside of the device and is configured to be associated with a respective line so as to receive therefrom, or to send thereto, fluid entering, or exiting from, said body of the device;
a third inlet/outlet opening, which sets said filtration chamber in communication with the outside of the device and is configured to be associated with a respective line so as to receive therefrom, or to send thereto, fluid entering, or exiting from, said body of the device.

In one aspect, the device is configured to operate a passage of fluid through said filtration chamber, in a selective manner according to a plurality of operative configurations, from one opening among said first inlet/outlet opening, second inlet/outlet opening and third inlet/outlet opening to another opening among said first inlet/outlet opening, second inlet/outlet opening and third inlet/outlet opening.

In one aspect, the device comprises filtering members that are at least partially housed inside said filtration chamber, or associated with said body of the device, and operatively interposed between said first inlet/outlet opening, second inlet/outlet opening and third inlet/outlet opening to carry out filtering of the fluid passing through the filtration chamber.

In one aspect, the device comprises a flow-directing insert that is housed inside said filtration chamber and configured to channel the fluid passing through the filtration chamber, in each one of said plurality of operative configurations, so that the fluid passes at least partially through said filtering members.

In one aspect, the device is configured to be associated with or installed along a delivery line, or in series with a delivery line, carrying a fluid to equipment of a plumbing and heating system, to operate a filtration of the fluid circulating in the system in a position upstream of such equipment.

In one aspect, the flow-directing insert is configured to operate selectively at least in either:
a first position for use, in which it channels the fluid circulating inside the filtration chamber so as to prevent direct passage of the fluid, without passing through the filtering members, from the first opening to the second opening or from the first opening to the third opening;
a second position for use, in which it channels the fluid circulating inside the filtration chamber so as to prevent direct passage of the fluid, without passing through the filtering members, from the second opening to the first opening or from the third opening to the first opening.

In one aspect, said plurality of operative configurations comprises at least:
a first operative configuration, in which said first opening receives a flow of fluid entering the device, said second opening sends the flow of filtered fluid exiting from the device and said third opening is intercepted by a closure element;
a second operative configuration, in which said first opening receives a flow of fluid entering the device, said third opening sends the flow of filtered fluid exiting from the device and said second opening is intercepted by a closure element;
a third operative configuration, in which said third opening receives a flow of fluid entering the device, said first opening sends the flow of filtered fluid exiting from the device and said second opening is intercepted by a closure element;
a fourth operative configuration, in which said second opening receives a flow of fluid entering the device, said first opening sends the flow of filtered fluid exiting from the device and said third opening is intercepted by a closure element.

In one aspect, the device comprises said closure element, configured to selectively intercept one opening among said first inlet/outlet opening, second inlet/outlet opening and third inlet/outlet opening.

In one aspect, the flow-directing insert is configured to be positioned selectively:
in said first position for use, when the device operates in said first operative configuration or in said second operative configuration;
in said second position for use, when the device operates in said third operative configuration or in said fourth operative configuration.

In one aspect, the flow-directing insert has a central axis, an external wall extending about said central axis and a passage section inside the external wall and perpendicular to the central axis, the insert having two opposite sides with respect to the central axis, wherein:
the first side is provided, on the external wall, with an edge that is raised with respect to the passage section, and a partition that intercepts said passage section;
the second side lacks a raised edge on the external wall and lacks a partition on the passage section, thus enabling the passage of fluid through the passage section, and it is provided with a separation portion emerging radially from the external wall.

In one aspect, the insert is structured in such a manner that:
the second side enables the passage of fluid, coming from the outside of the insert, through the passage section, along a first direction along said central axis;
the first side obstructs the passage of fluid, coming from the outside of the insert, through the passage section, and determines a process of directing it along a second direction along said central axis, opposite said first direction.

In one aspect, said first side and said second side constitute two halves of said insert which face each other and are connected along a dividing plane in which the central axis of the insert lies.

In one aspect:
in said first position for use, the insert is positioned in such a manner that the first side thereof faces the third inlet/outlet opening and the second side thereof faces the first inlet/outlet opening;
in said second position for use, the insert is positioned in such a manner that the first side thereof faces the first inlet/outlet opening and the second side thereof faces the third inlet/outlet opening.

In one aspect, the flow-directing insert is located inside the filtration chamber, in such a manner as to surround the second inlet/outlet opening.

In one aspect, the filtration chamber is delimited laterally by a lateral surface, above by a top surface and below by a bottom surface of the body of the device.

In one aspect, the second inlet/outlet opening is provided with a dividing wall extending inside the filtration chamber and located between the longitudinal axis of the body of the device and the first inlet/outlet opening. In one aspect, said dividing wall extends, starting from the second inlet/outlet opening, inside the filtration chamber along a direction parallel to the longitudinal axis of the body of the device and substantially to a height coinciding with the dimensions of the first inlet/outlet opening on the external lateral surface of the body of the device.

In one aspect, the dividing wall extends, inside the filtration chamber, from the top surface delimiting the chamber from above.

In one aspect, the dividing wall ends below with a portion for diverting the fluid, which extends towards the longitudinal axis of the body of the device.

In one aspect, the insert is located inside the filtration chamber, in such a manner that the external wall externally surrounds the diverting portion of the dividing wall.

In one aspect, the diverting portion of the dividing wall is complementarily shaped with respect to the partition of the first side of the insert.

In one aspect, the positioning of the insert and the diverting portion of the dividing wall with respect to each other is such as to determine that:
when the insert is selectively set into said first position for use, the first side of the insert is on the side opposite the diverting portion with respect to the longitudinal axis of the body, and facing it, so that the partition and the diverting portion completely intercept the passage section of the insert, preventing the passage of fluid through the passage section;
when the insert is selectively set into said second position for use, the first side of the insert is on the same side as the diverting portion, with respect to the longitudinal axis, and externally embraces the diverting portion, whereas the second side of the insert is on the side opposite the diverting portion with respect to the longitudinal axis of the body, and as the second side lacks a partition, it enables the passage of fluid through the passage section.

In one aspect, when the insert is selectively set into said first position for use, surface continuity is created between the partition and the diverting portion and it is such as to completely intercept the passage section of the insert.

In one aspect, the filtering members comprise a mechanical filter configured to separate substances and solid particles present in the fluid to be treated from the fluid itself in which they are suspended, the mechanical filter having a structure provided with a plurality of passages that have a given filtering section, so that the passage of the fluid from one internal side of the mechanical filter to an external side of the mechanical filter determines retention, on the internal side, of the substances and particles present in the fluid and having dimensions greater than said filtering section. On the other hand, if the passage of the fluid takes place from the external side of the structure to the internal side of the structure, the retention of the substances and particles present in the fluid and having a larger dimension than said filtering section takes place on the external side.

In one aspect, the filtering members comprise a magnetic filter associated with the body of the device and configured to collect and retain substances and ferrous particles (or particles having ferromagnetic properties) that are present in the fluid to be treated, in such a manner as to separate them from the fluid passing through the device.

In an independent aspect thereof, the present invention relates to a heating system comprising a device according to one or more of the above aspects.

In an independent aspect thereof, the present invention relates to a method for filtering a fluid circulating in a plumbing and heating system, comprising the steps of:
arranging at least one device for filtering a fluid;
identifying a line coming from a plumbing and heating system, particularly a heating water return line from a system of heating elements, carrying a flow of water to be subjected to filtration;
identifying a line directed to a boiler of the plumbing and heating system, this line carrying a flow of water that has undergone filtration to the boiler;
operating the device selectively in one of the following operative configurations:
a first operative configuration, comprising the steps of:
   hydraulically connecting the first inlet/outlet opening with a line coming from a plumbing and heating system, particularly a heating water return line from a system of heating elements, so as to receive a flow of water to be subjected to filtration;
   hydraulically connecting the second inlet/outlet opening with a line directed to a boiler of the plumbing and heating system, so as to send thereto the flow of water following filtration;
   intercepting the third inlet/outlet opening by means of a closure element;
   positioning the flow-directing insert in said first position for use;
   via the second side of the insert, and via the outside of the dividing wall, conveying the flow of fluid entering the first opening directly through the passage section of the insert and from there to the second portion of the filtration chamber inside the mechanical filter, where the fluid is filtered by the magnetic filter;
   making the fluid flow out, through the mechanical filter, from the second portion of the filtration chamber so as to make it pass into the first portion of the filtration chamber, and from there conveying it through the first side of the insert, towards the second opening, the fluid not being able to pass through the passage section again because of the partition of the first side of the insert and the diverting portion of the dividing wall;
a second operative configuration, comprising the steps of:
   hydraulically connecting the first inlet/outlet opening with a line coming from a plumbing and heating system, particularly a heating water return line from a system of heating elements, so as to receive a flow of water to be subjected to filtration;
   intercepting the second inlet/outlet opening by means of a closure element;
   hydraulically connecting the third inlet/outlet opening with a line directed to a boiler of the plumbing and heating system, so as to send thereto the flow of water following filtration;
   positioning the flow-directing insert in said first position for use;
   via the second side of the insert, and via the outside of the dividing wall, conveying the flow of fluid entering the first opening directly through the passage section of the insert and from there to the second portion of the filtration chamber inside the mechanical filter, where the fluid is filtered by the magnetic filter;
   making the fluid flow out, through the mechanical filter, from the second portion of the filtration chamber so as to make it pass into the first portion of the filtration chamber, and from there conveying it through the first side of the insert, towards the third opening, the fluid not being able to pass through the passage section again because of the partition of the first side of the insert and the diverting portion of the dividing wall;
a third operative configuration, in which:
   the third inlet/outlet opening is hydraulically connected with a line coming from a plumbing and heating system, particularly a heating water return line from a system of heating elements, so as to receive a flow of water to be subjected to filtration;
   the second inlet/outlet opening is intercepted by a closure element;
   the first inlet/outlet opening is hydraulically connected with a line directed to a boiler of the plumbing and heating system, so as to send thereto the flow of water following filtration;
   the flow-directing insert is positioned in said second position for use;
   via the second side of the insert, the flow of fluid entering the third opening is conveyed directly through the passage section of the insert and from there to the second portion of the filtration chamber inside the mechanical filter, where the fluid is filtered by the magnetic filter;
   the fluid flows out, through the mechanical filter, from the second portion of the filtration chamber and passes into the first portion of the filtration chamber, and from there it is conveyed through the first side of the insert towards the first opening, the fluid not being able to pass through the passage section again because of the raised edge of the first side of the insert and the outside of the dividing wall;
a fourth operative configuration, comprising the steps of:
   hydraulically connecting the second inlet/outlet opening with a line coming from a plumbing and heating system, particularly a heating water return line from a system of heating elements, and receiving a flow of water to be subjected to filtration;
   intercepting the third inlet/outlet opening by means of a closure element;
   hydraulically connecting the first inlet/outlet opening with a line directed to a boiler of the plumbing and heating system, so as to send thereto the flow of water following filtration;
   positioning the flow-directing insert in said second position for use;
   via the second side of the insert, conveying the flow of fluid entering the second opening directly through the passage section of the insert and from there to the second portion of the filtration chamber inside the mechanical filter, where the fluid is filtered by the magnetic filter;
   making the fluid flow out, through the mechanical filter, from the second portion of the filtration chamber so as to make it pass into the first portion of the filtration chamber, and from there conveying it through the first side of the insert towards the first opening, the fluid not being able to pass through the passage section again because of the raised edge of the first side of the insert and the outside of the dividing wall.

Each of the aforesaid aspects of the invention can be taken on its own or in combination with any of the claims or the other aspects described.

Additional features and advantages will become more apparent from the detailed description of some example, but not exclusive, embodiments, including a preferred embodiment, of a device and a method for filtering a fluid circulating in a plumbing and heating system in accordance with the present invention. This description is provided herein below with reference to the attached drawings, which are provided solely for purpose of providing approximate and thus non-limiting examples, and of which:

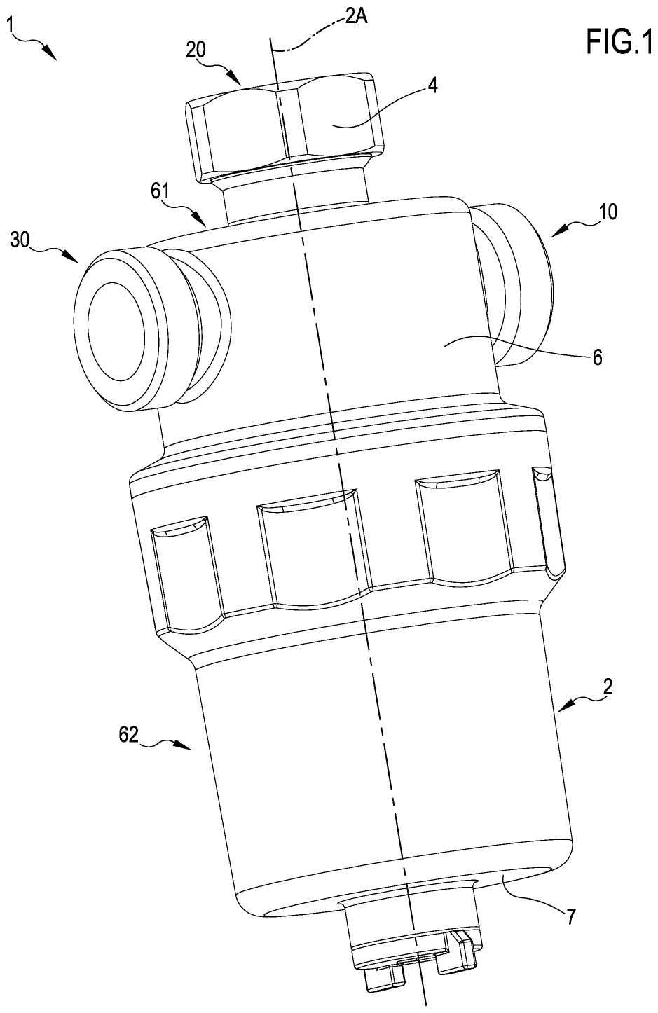

FIG. 1 illustrates a possible embodiment of a device for filtering a fluid according to the present invention;

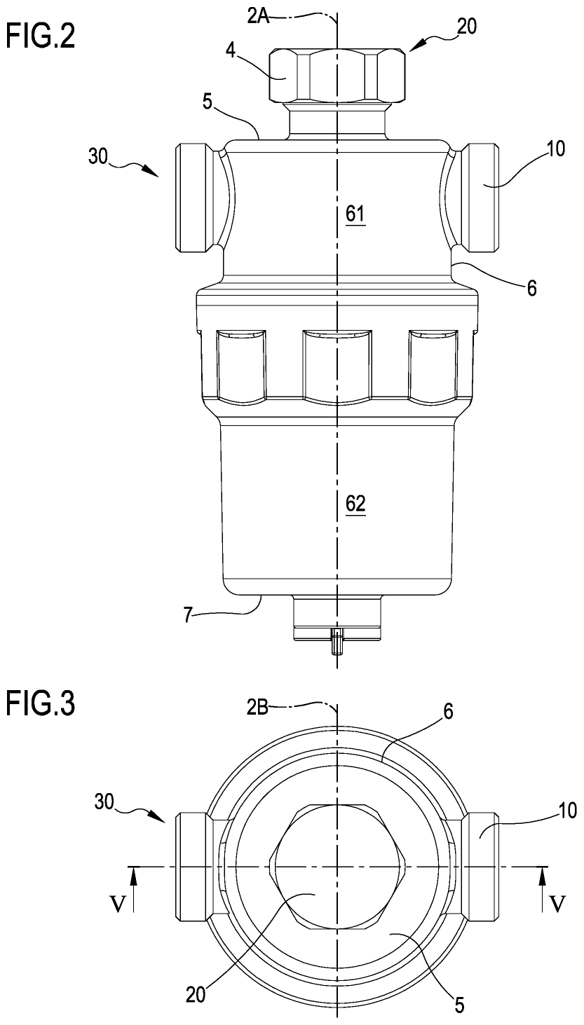

FIG. 2 shows a front view of the device of FIG. 1;

FIG. 3 shows a top view of the device of FIG. 1;

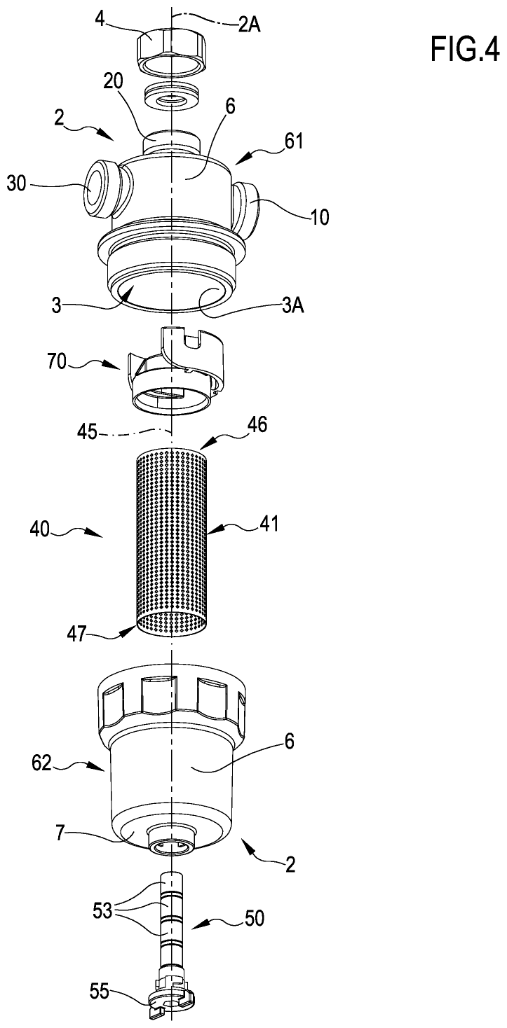

FIG. 4 shows an exploded perspective view of the device of FIG. 1;

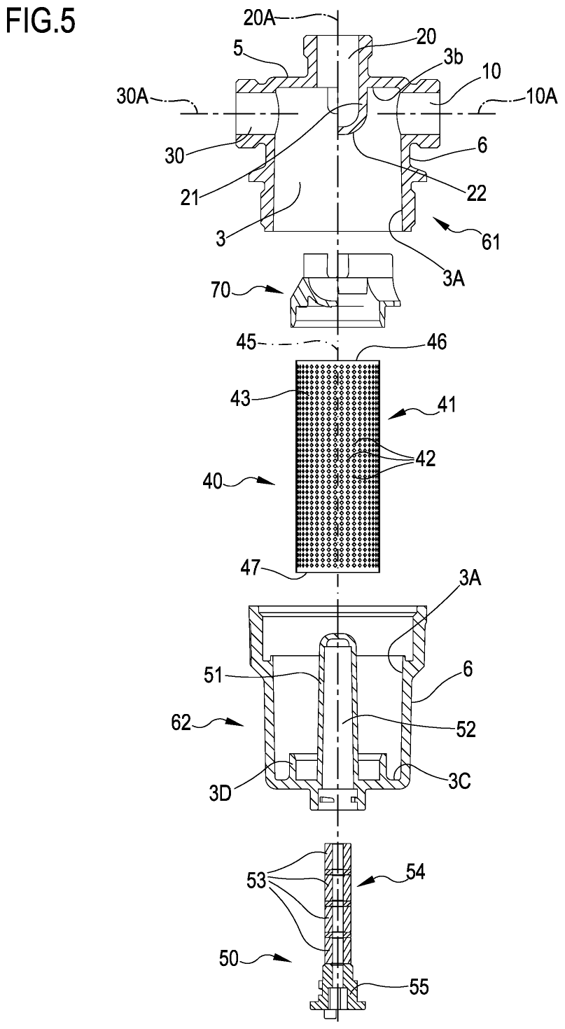

FIG. 5 shows a sectional view, along the plane V-V, and exploded view of the device of FIG. 1, along a longitudinal direction, with some parts removed;

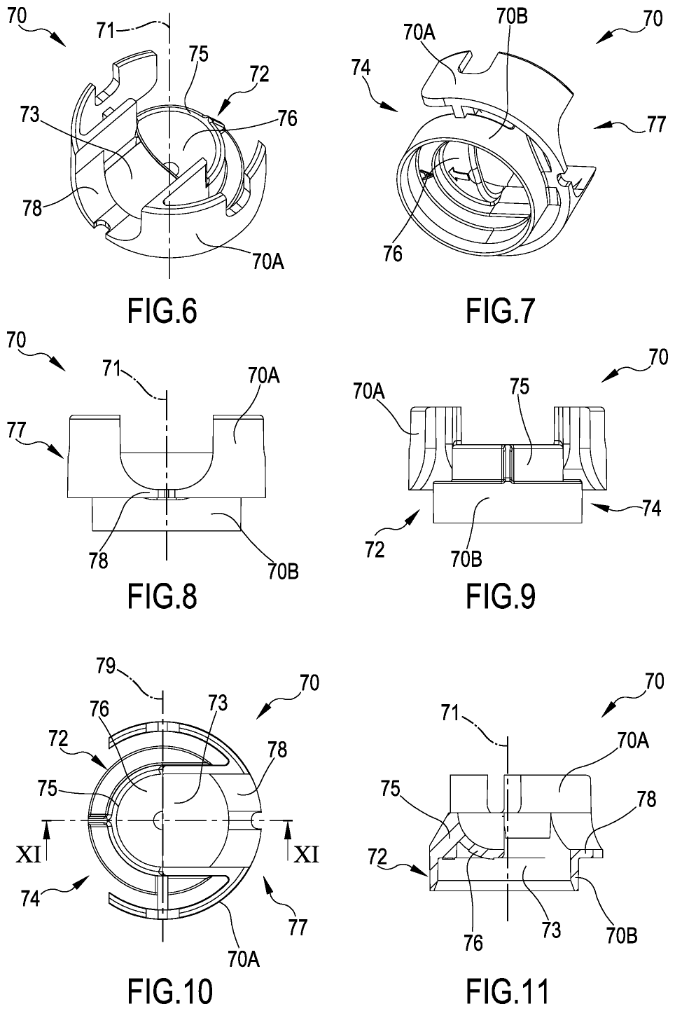

FIG. 6 shows a perspective view of a flow-directing insert that is part of the device of FIG. 1;

FIG. 7 shows a further perspective view of the insert of FIG. 6;

FIG. 8 shows a side view, from the left with respect to FIG. 6, of the insert of FIG. 6;

FIG. 9 shows a side view, from the right with respect to FIG. 6, of the insert of FIG. 6;

FIG. 10 shows a top view of the insert of FIG. 6;

FIG. 11 shows a middle sectional view, along the plane XI-XI, of the insert of FIG. 6;

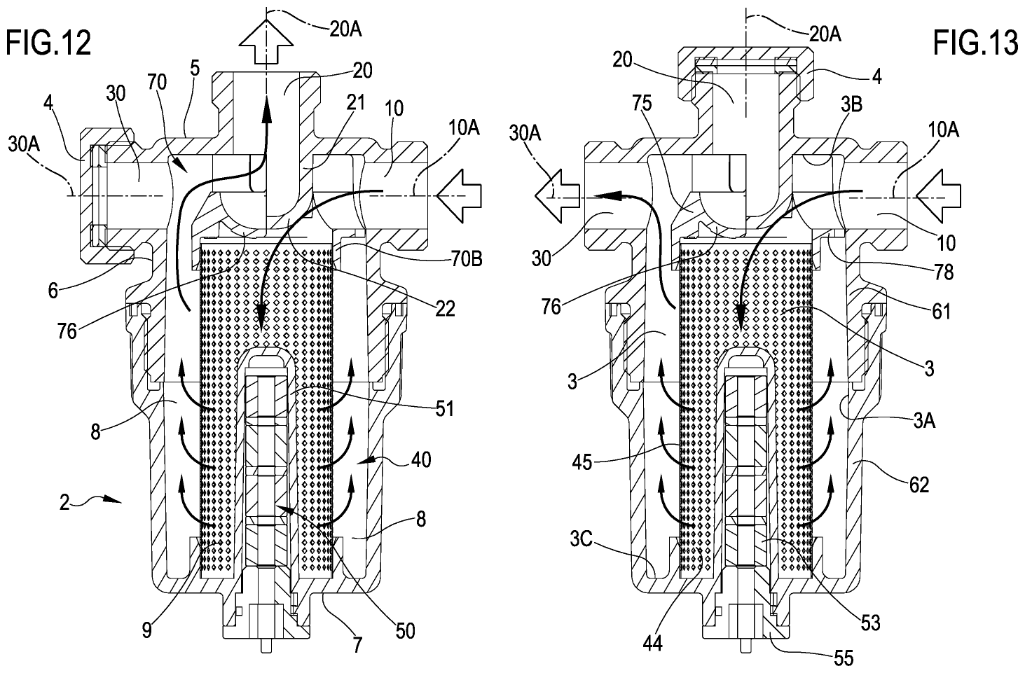

FIG. 12 shows the device of FIG. 1, sectioned along the plane V-V in a first operative configuration;

FIG. 13 shows the device of FIG. 1, sectioned along the plane V-V in a second operative configuration;

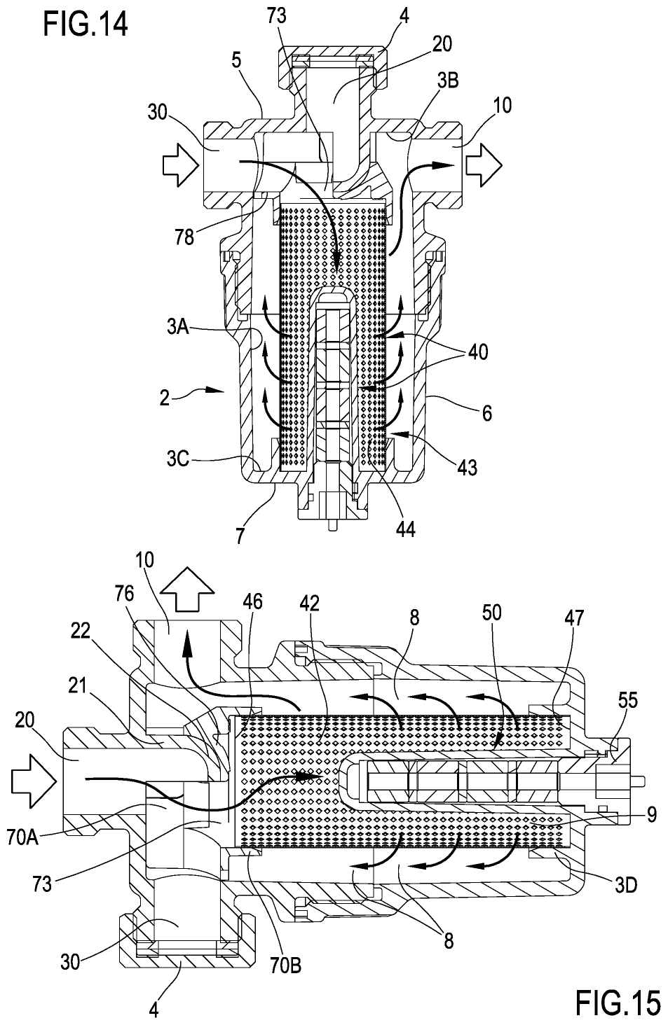

FIG. 14 shows the device of FIG. 1, sectioned along the plane V-V in a third operative configuration;

FIG. 15 shows the device of FIG. 1, sectioned along the plane V-V in a fourth operative configuration.

With reference to the above-mentioned figures, the reference number 1 denotes in its entirety a device for filtering a fluid in accordance with the present invention. In general, the same reference number is used for identical or similar elements, possibly in the variant embodiments thereof.

The device 1 is intended to carry out the filtration of the fluid, typically water, circulating inside a plumbing and heating system, usually comprising pipes and conduits, valves, a boiler or a power generator, pumps, radiant elements (heaters, radiators, floor heating coils, etc.), utilities, etc.

In the figures the system for which the device is intended is not illustrated or described in a detailed manner, since it is in itself known in the technical field of the present invention.

The device 1 comprises first of all a body 2, which defines therewithin a filtration chamber 3 intended to have a fluid to be subjected to filtration pass through it. The body 2 is provided with a first inlet/outlet opening 10, a second inlet/outlet opening 20 and a third inlet/outlet opening 30: each one of them sets said filtration chamber 3 in communication with the outside of the device and is configured to be associated with a line of the system so as to receive therefrom, or to send thereto, fluid entering, or exiting from, said body of the device.

The device 1 is configured to operate a passage of fluid through the filtration chamber 3, from one opening among said first opening 10, second opening 20 and third inlet/outlet opening 30 to another opening among said first opening 10, second opening 20 and third inlet/outlet opening 30. The two openings (among the aforesaid three openings 10, 20 and 30) between which the passage of fluid takes place can be selected as desired, according to a plurality of operative configurations, as will emerge more clearly below.

The device 1 comprises filtering members 40 that are at least partially housed inside the filtration chamber 3, or associated with the body 2 of the device, and operatively interposed between the three inlet/outlet openings 10, 20 and 30, to carry out filtering of the fluid passing through the filtration chamber 3.

The device 1 further comprises a flow-directing insert 70 that is housed inside the filtration chamber 3 and configured to channel the fluid passing through the filtration chamber, in each one of the plurality of operative configurations, so that the fluid always passes at least partially through the filtering members 40.

In particular, the flow-directing insert 70 is configured to operate selectively at least in either:
a first position for use, in which it channels the fluid circulating inside the filtration chamber 3 so as to prevent direct passage of the fluid, without passing through the filtering members 40, from the first opening 10 to the second opening 20 or from the first opening 10 to the third opening 30;
a second position for use, in which it channels the fluid circulating inside the filtration chamber 3 so as to prevent direct passage of the fluid, without passing through the filtering members 40, from the second opening 20 to the first opening 10 or from the third opening 30 to the first opening 10.

The device preferably comprises a closure element 4 configured to selectively intercept one opening among the aforesaid first opening 10, second opening 20 and third inlet/outlet opening 30.

According to a preferred embodiment, the plurality of operative configurations comprises:
a first operative configuration, in which the first opening 10 receives a flow of fluid entering the device, the second opening 20 sends the flow of filtered fluid exiting from the device and the third opening is intercepted by the closure element 4;
a second operative configuration, in which the first opening 10 receives a flow of fluid entering the device, the third opening 30 sends the flow of filtered fluid exiting from the device and the second opening 20 is intercepted by the closure element 4;
a third operative configuration, in which the third opening 30 receives a flow of fluid entering the device, the first opening 10 sends the flow of filtered fluid exiting from the device and the second opening 20 is intercepted by the closure element 4;
a fourth operative configuration, in which the second opening 20 receives a flow of fluid entering the device, the first opening 10 sends the flow of filtered fluid exiting from the device and the third opening 30 is intercepted by the closure element 4.

The closure element 4 is preferably a cap, removably associable with the openings.

It is evident that in each one of the operative configurations, one of the three openings acts as an inlet, another of the three openings acts as an outlet and the remaining opening is closed off and preferably not used.

The operative configurations are represented in FIGS. 12-15, and will be discussed in detail in the description below.

Given the four configurations identified above, the flow-directing insert 70 is configured to be positioned selectively:
in the aforesaid first position for use (FIGS. 12 and 13), when the device operates in the first operative configuration or in the second operative configuration;
in the aforesaid second position for use (FIGS. 14 and 15), when the device operates in the third operative configuration or in the fourth operative configuration.

According to the embodiment shown by way of example in the figures, and in particular in FIGS. 6-11, the flow-directing insert 70 has a central axis 71, an external wall 72 extending about the central axis and a passage section 73 inside the external wall and perpendicular to the central axis. The external wall 72 preferably extends completely about the central axis 71, so as to form a closed loop structure, which defines therewithin the passage section 73. The insert 70 preferably has two opposite sides with respect to the central axis 71, that is, a first side 74 and a second side 77, wherein:
the first side 74 is provided, on the external wall 72, with an edge 75 that is raised with respect to the passage section 73, and a partition 76 that intercepts the passage section;
the second side 77 lacks a raised edge on the external wall and lacks a partition on the passage section, thus enabling the passage of fluid through the passage section 73, and is provided with a separation portion 78 emerging radially from the external wall 72, away from the central axis 71.

The separation portion 78 of the second side 77 is substantially in the place of the raised edge 75 on the first side 74. The separation portion is preferably configured to horizontally convey a flow of fluid coming from the outside of the second side, whereas the raised edge is configured to prevent a passage of flow from the outside of the external wall towards the inside of the insert 70.

The separation portion 78 is preferably substantially aligned with the passage section 73.

The insert 70 is preferably structured in such a manner that:
the second side 77 enables the passage of fluid, coming from the outside of the insert 70, through the passage section 73, along a first direction along the central axis 71;
the first side 74 obstructs the passage of fluid, coming from the outside of the insert 70, through the passage section 73, and determines a process of directing it along a second direction along the central axis 71, opposite the first direction.

In FIGS. 4-15 the aforesaid first direction along the central axis 71 is turned downwards, whereas the aforesaid second direction is turned upwards.

The first side 74 and the second side 77 preferably constitute two halves of the insert 70 which face each other and are connected along a dividing plane 79 in which the central axis 71 of the insert lies.

The insert 70 is preferably made of a single piece. The insert 70 is preferably made of a plastic or metal material.

The insert 70 is preferably symmetric (or specular) with respect to a plane of symmetry (the plane XI-XI in FIG. 10) in which the central axis 71 lies and perpendicular to the dividing plane 79.

According to the embodiment shown by way of example in the figures, and in particular in FIGS. 1-5 and 12-15, the body 2 of the device has a substantially cylindrical shape and it has a longitudinal axis 2A, an upper surface 5, an external lateral surface 6 and a lower surface 7.

The body preferably has the conformation of a solid rotating about the longitudinal axis 2A and has a radial symmetry thereabout.

The first inlet/outlet opening 10 and the third inlet/outlet opening 30 are preferably located on the external lateral surface 6 of the body 2 of the device and on opposite sides with respect to the filtration chamber 3.

The second inlet/outlet opening 20 is preferably located on the upper surface 5 of the body 2 of the device.

The first inlet/outlet opening 10, the second inlet/outlet opening 20 and the third inlet/outlet opening 30 preferably have a circular cross section and each one has a respective central axis (the central axes of the openings are indicated in the figures by 10A, 20A and 30A, respectively).

The central axis 20A of the second inlet/outlet opening 20 preferably coincides with the longitudinal axis 2A of the body 2 of the device.

All three of the respective central axes 10A, 20A and 30A of the first inlet/outlet opening 10, of the second inlet/outlet opening 20 and of the third inlet/outlet opening 30 preferably intersect (preferably in a same point inside the filtration chamber 3) the longitudinal axis 2A of the body 2 of the device.

The respective central axes 10A and 30A of the first inlet/outlet opening 10 and of the third inlet/outlet opening 30 are preferably orthogonal to the longitudinal axis 2A of the body 2 of the device.

The respective central axes 10A and 30A of the first inlet/outlet opening 10 and of the third inlet/outlet opening 30 preferably coincide with each other.

The body of the device preferably has a central plane of symmetry V-V in which the longitudinal axis 2A lies, said central plane of symmetry dividing the body 2 of the device into two substantially identical halves. The plane V-V is indicated in FIG. 3, and the sections in FIGS. 5 and 12-15 are drawn with respect to it.

The body of the device is substantially symmetric also with respect to a median plane 2B, in which the longitudinal axis 2A lies and which is orthogonal to the central plane of symmetry V-V.

All three of the respective central axes 10A, 20A and 30A of the first opening 10, of the second opening 20 and of the third opening 30 preferably lie in the plane of symmetry V-V of the body 2 of the device.

The central axis 71 of the insert 70 preferably coincides with the longitudinal axis 2A of the body 2 of the device.

The central axis 71 of the insert 70 preferably coincides with the respective central axis 20A of the second inlet/outlet opening 20.

According to a preferred embodiment:
in the first position for use (FIGS. 12 and 13), the insert 70 is positioned in such a manner that the first side thereof 74 faces the third inlet/outlet opening 30 and the second side 77 thereof faces the first inlet/outlet opening 10;
in the second position for use (FIGS. 14 and 15), the insert 70 is positioned in such a manner that the first side thereof 74 faces the first inlet/outlet opening 10 and the second side 77 thereof faces the third inlet/outlet opening 30.

The passage of the insert 70 between the first position for use and the second position for use preferably takes place by means of a rotation, preferably of 180°, of the insert itself about its own central axis 71 (i.e. with respect to the longitudinal axis 2A of the body 2).

The flow-directing insert 70 is preferably located inside the filtration chamber 3, in such a manner as to surround the second inlet/outlet opening 20.

The filtration chamber 3 is preferably delimited laterally by a lateral surface 3A, above by a top surface 3B and below by a bottom surface 3C of the body 2 of the device.

The second inlet/outlet opening 20 is preferably provided with a dividing wall 21 extending inside the filtration chamber 3 and located between the longitudinal axis 2A of the body 2 and the first inlet/outlet opening 10.

In other words, the dividing wall 21 extends, inside the filtration chamber 3, entirely in one half of the filtration chamber comprised between the median plane 2B, orthogonal to the central plane of symmetry V-V of the body 2 and in which the longitudinal axis 2A lies, and the first inlet/outlet opening 10. An example embodiment of the dividing wall is shown in FIGS. 5 and 12-15.

The dividing wall 21 preferably extends, starting from the second inlet/outlet opening 20, inside the filtration chamber 3 along a direction parallel to the longitudinal axis 2A of the body 2 of the device and substantially to a height coinciding with the dimensions of the first inlet/outlet opening 10 on the external lateral surface 6 of the body 2.

The dividing wall 21 preferably extends, inside the filtration chamber 3, starting from the top surface 3B delimiting the filtration chamber 3 from above.

The dividing wall 21 is preferably fixed with respect to the body 2 of the device.

The dividing wall 21 preferably ends below with a portion for diverting 22 the fluid, which extends towards the longitudinal axis 2A of the body of the device.

The flow-directing insert 70 is preferably located, inside the filtration chamber 3, in such a manner that its external wall 72 externally surrounds the diverting portion 22 of the dividing wall 21.

The diverting portion 22 of the dividing wall 21 is preferably complementarily shaped with respect to the partition 76 of the first side 74 of the insert 70.

Observe FIGS. 12-15. The positioning of the flow-directing insert 70 and the diverting portion 22 of the dividing wall 21 with respect to each other is preferably such as to determine that:
when the insert 70 is selectively set into the first position for use (FIGS. 12 and 13), the first side 74 of the insert is on the side opposite the diverting portion 22 with respect to the longitudinal axis 2A of the body 2, and facing it, so that the partition 76 and the diverting portion 22 completely intercept the passage section 73 of the insert, preventing the passage of fluid through the passage section 73;
when the insert is selectively set into the second position for use (FIGS. 14 and 15), the first side 74 of the insert is on the same side of the diverting portion 22 with respect to the longitudinal axis 2A, and externally embraces the diverting portion 22, whereas the second side 77 of the insert 70 is on the side opposite the diverting portion 22 with respect to the longitudinal axis 2A, and as the second side 77 lacks a partition, it enables the passage of fluid through the passage section 73.

In other words:
when the insert 70 is selectively set into the first position for use (FIGS. 12 and 13), the partition 76 intercepts one half of the passage section 73 of the insert, thus obstructing the passage of fluid, and the diverting portion 22 intercepts the other half of the passage section 73 of the insert, thus obstructing in turn the passage of fluid; the partition 76 and the diverting portion 22 together entirely block off the passage of fluid through the passage section 73;
when the insert 70 is selectively set into the second position for use (FIGS. 14 and 15), the partition 76 is on the same side as the diverting portion 22, and fits together with it, as the partition and the diverting portion are complementarily shaped with respect to each other; the partition 76 and the diverting portion 22 intercept a same half of the passage section 73 of the insert 70, thus obstructing the passage of fluid in that half only; in contrast, the second side 77 of the insert is on the side opposite the diverting portion (and the partition) and, since the second side lacks a partition, the half of the passage section 73 affected by the second side 77 of the insert can have the fluid flow through it.

When the insert 70 is selectively set into the first position for use, surface continuity is preferably created between the partition and 76 the diverting portion 22 and it is such as to completely intercept the passage section 73 of the insert.

The first position for use and the second position for use of the insert 70 are preferably opposite each other with respect to the longitudinal axis 2A of the body 2 of the device.

Preferably, as shown in the figures, the partition 76 of the insert 70 substantially has the shape of a portion of a spherical crown (or a portion of a spherical shell); it preferably has the shape of a quarter of a spherical crown (or a quarter of a spherical shell).

Preferably, the diverting portion 22 of the dividing wall 21 substantially has a respective shape of a portion of a spherical crown (or a portion of a spherical shell); it preferably has the shape of a quarter of a spherical crown (or a quarter of a spherical shell).

Preferably, the partition 76 of the insert 70 substantially has a “half cup” shape, and has a surface having a given radius of curvature with respect to a centre.

Preferably, the diverting portion 22 of the dividing wall 21 substantially has a respective “half cup” shape, and has a surface having a given radius of curvature with respect to a centre.

The complementary shape of the partition 76 of the insert 70 with respect to the diverting portion 22 of the dividing wall 21 is preferably obtained by means of an appropriate dimensioning of the radii of the spherical crown portion defining the partition 76 and of the radii of the spherical crown portion defining the diverting portion 22.

The shape of a portion of a spherical crown (or a portion of a spherical shell or “half cup”) of the partition 76 and of the diverting portion 22 enable the rotation of the insert 70 (movable) with respect to the diverting portion 22 (fixed) and thus the passage of the insert between the first position for use and the second position for use, otherwise impossible due to dimensional interference. The passage of the insert from the first to the second position for use takes place with a rotation of 180°, which determines a sliding of the partition 76 under the diverting portion 22 (with the “opening” of half of the passage section 73); an opposite rotation of 180°, whereby the insert passes from the second to the first position for use, brings the partition 76 side by side with the diverting portion 22 so as to form a complete spherical half-shell (or half spherical crown) which completely blocks off the passage section 73.

It should be observed that the dividing wall 21 and the diverting portion 22 are part of the body of the device, but they are functionally attributable to the second inlet/outlet opening 20.

The first opening 10, the second opening 20 and the third inlet/outlet opening 30 preferably have the same shape and size; more preferably, they are identical to one another.

The closure element 4 can preferably be selectively applied on any of the three inlet/outlet openings 10, 20 and 30, so as to determine the closure thereof. The first inlet/outlet opening 10, the second inlet/outlet opening 20 and the third inlet/outlet opening 30 preferably have respective interconnection means configured to fluidly connect the opening with external pipes, fittings or water valves. The interconnection means are preferably configured also to receive the closure element 4. The interconnection means preferably comprise threads or pressure connections or like mechanisms. The interconnection means of the first inlet/outlet opening 10, the second inlet/outlet opening 20 and the third inlet/outlet opening 30 are preferably structurally identical to one another. By way of example, the three inlet/outlet openings 10, 20 and 30 have standard sizes for the plumbing sector, for example a ¼ inch, ½ inch, ¾ inch or 1 inch diameter.

Reference will now be made in particular to FIGS. 4-5 and 12-15.

The filtering members 40 preferably comprise a mechanical filter 41 configured to separate substances and solid particles present in the fluid to be treated from the fluid itself in which they are suspended. The mechanical filter 41 has a structure provided with a plurality of passages 42 that have a given filtering section, so that the passage of the fluid from an external side 43 of the structure to an internal side 44 of the structure determines retention, on the external side 43, of the substances and particles present in the fluid and having dimensions greater than the filtering section. In a wholly like manner, the passage of the fluid from the internal side 44 of the structure to the external side 43 of the structure determines retention, on the internal side 44, of the substances and particles present in the fluid and having dimensions greater than the filtering section.

The structure preferably has a meshwork (or a grid or a mesh or a fabric) or a plurality of micro holes.

The mechanical filter 41 is preferably made of metal material, preferably stainless steel.

The mechanical filter 41 preferably has a cylindrical shape extending around a central axis 45 between a first end 46 (upper end in the figures) and a second end 47 (lower end in the figures), and is positioned inside the filtration chamber 3 in such a manner that the central axis 45 coincides with the longitudinal axis 2A of the body 2 of the device.

At least the first end 46 of the mechanical filter 41 is preferably open.

The mechanical filter 41 preferably has a radial dimension (or diameter) that is smaller than the respective radial dimension (or respective diameter) of the filtration chamber 3, so as to be distanced from the lateral surface 3A of the chamber and define, inside the chamber 3, a first chamber portion 8 outside the mechanical filter 41 and a second chamber portion 9 inside the mechanical filter 41.

The mechanical filter 41 is preferably positioned axially between the bottom surface 3C of the body 2 and the flow-directing insert 70.

The external wall 72 of the insert 70 preferably comprises an upper collar 70A, configured to be positioned so as to abut on the top surface 3B of the filtration chamber 3, and a lower collar 70B, axially opposite the upper collar and configured to house the first end 46 of the mechanical filter 41.

The bottom surface 3C of the filtration chamber 3 preferably comprises an annular seat 3D configured to house the second end 47 of the mechanical filter 41.

In this manner, the mechanical filter 41 is axially and removably interposed between the lower collar 70B of the insert 70 and the annular seat 3D of the bottom surface 3C.

The lower collar 70B preferably has a diameter corresponding to the diameter of the mechanical filter 41. The annular seat 3D preferably has, internally or externally, a diameter corresponding to the diameter of the mechanical filter 41. In this manner, the centring of the mechanical filter 41 with respect to the longitudinal axis and with respect to the insert 70 is guaranteed.

The mechanical filter 41 is preferably positioned under the insert 70 so as not to be directly facing the three openings 10, 20 and 30.

The mechanical filter 41 is preferably positioned in the filtration chamber 3 so as to be in fluid communication with the three openings 10, 20 and 30, but under them along the longitudinal axis 2A of the body of the device (in a direction away from the second opening 20, or downwards according to the orientation shown in the figures).

The insert 70 is preferably in contact, at the bottom thereof, and axially aligned, with the mechanical filter 41.

The insert 70 is positioned between the top surface 3B and the first end of the mechanical filter; in this manner, the insert, once positioned in the phase of assembly and configuration of the device 1, remains stable throughout the operation of the device. However, the positioning of the insert is reversible, and this makes it possible to move the insert between the first and the second position for use every time there is an intention to modify the configuration of use (among the aforesaid four configurations) or disassemble the device completely for cleaning or maintenance operations.

As shown in FIGS. 12-15, the separation portion 78 of the second side 77 of the insert is preferably shaped so as to be radially in contact with the lateral surface 3A of the filtration chamber 3, at the first opening 10 when the insert is in the first position for use and at the third opening 30 when the insert is in the second position for use. In this manner, the separation portion 78 prevents the passage of the fluid entering, respectively, from the first opening 10 (when the device operates in the first or second configuration, FIGS. 12 and 13) or from the second 20 or third opening 30 (in the third or fourth configuration, respectively, FIGS. 14 and 15), in the first portion 8 of the filtration chamber 3 (outside the mechanical filter 41), conveying the fluid horizontally directly towards the passage section 73 and from there into the second portion 9 of the filtration chamber 3.

This means that the separation portion 78 vertically separates, in all of the operative configurations, the opening from which the entry of the fluid takes place (based on the configuration) from the first portion 8 of the filtration chamber 3, thus forcing the entry of the fluid into the second portion 9 of the filtration chamber.

In other words, as may be seen in the figures, during the entry of the fluid, the separation portion 78 acts as a wall separating the upper part of the filtration chamber 3, into which the three openings 10, 20 and 30 lead, from the lower part, wherein the first chamber portion 8 outside the mechanical filter is defined.

It should be noted that, preferably, the first portion 8 of the separation chamber has the form of a hollow cylinder, where the hollow part is represented by the second portion 9 defined and delimited by the mechanical filter 41.

The filtering members 40 preferably comprise a magnetic filter 50 associated with the body 2 of the device and configured to collect and retain ferrous substances and particles (or in general ones having ferromagnetic properties) that are present in the fluid to be treated, in such a manner as to separate them from the fluid passing through the device.

The body 2 of the device preferably comprises a hollow protuberance 51 that emerges axially from the bottom surface 3C towards the top surface 3B, said hollow protuberance 51 defining, outside the body of the device, a housing 52 that is elongated in shape, corresponding (negatively) to the hollow protuberance 51 and accessible from the lower surface 7.

The magnetic filter 50 preferably comprises at least one magnetic element 53, which is configured to generate a permanent magnetic field and is inserted in the housing 52 of the body 2 in such a manner as to act upon the fluid passing through the filtration chamber 3 and retain the ferrous substances and particles present in the fluid on the surface of the hollow protuberance 51 inside the body 2 (in particular inside the chamber). Essentially, the magnetic filter 50 is positioned “inside” the filtration chamber, even if it is physically in the housing 52 accessible from outside the body 2 without accessing the filtration chamber.

The magnetic filter 50 preferably comprises a plurality of magnetic elements 53 associated with one another so as to form a rod-shaped magnetic cartridge 54 axially inserted into the housing 52 of the body of the device.

The body 2 of the device preferably comprises, on the lower surface 7, at the point of access to the housing 52, a cap 55 suitable for closing said at least one magnetic element 53 or said magnetic cartridge 54 inside the housing 52 and for enabling the extraction thereof as needed.

The hollow protuberance 51 emerging from the bottom surface is preferably entirely contained inside the mechanical filter 41, so that the magnetic filter 50 is positioned inside the second portion 9 of the filtration chamber 3. In this configuration, though the magnetic filter 50 is not in direct contact with the flow, that is, it is not directly touched by the fluid circulating in the filtration chamber, by virtue of its position and its magnetic effect it enables the ferrous particles on the hollow protuberance inside the body to be blocked. The device preferably comprises a removable sheath which wraps the hollow protuberance inside the filtration chamber. The ferrous material filtered out deposits on the sheath and, by removing the mechanical filter and opening the body of the device, it is possible to remove the sheath and clean it of the filtered material.

In an alternative embodiment, not shown, the magnetic filter can be housed directly inside the filtration chamber.

The body 2 preferably comprises a first half-body 61 and a second half-body 62, removably associated with each other, wherein:
the assembly of the first half-body 61 with the second half-body 62 defines the filtration chamber 3, inside the body of the device, which is fluid tight towards the outside, with the exception of said first inlet/outlet opening 10, second inlet/outlet opening 20 and third inlet/outlet opening 30;
the disassembly of the first half-body 61 from the second half-body 62 enables access to the filtration chamber 3 and positioning of the flow-directing insert 70.

Preferably:
the first half-body 61 comprises the first opening 10, the second opening 20, the third inlet/outlet opening 30, the top surface 3B and the dividing wall 21 and houses the flow-directing insert 70;
the second half-body 62 comprises the bottom surface 3C and the hollow protuberance 51.

The lateral surface 3A of the filtration chamber 3 is preferably defined in part by the first half-body 61 and in part by the second half-body 62.

The first half-body and the second half-body are preferably interconnected by means of a threaded coupling (not shown, of a known type).

The body 2 of the device preferably comprises a gasket interposed between the first half-body 61 and the second half-body 62 to ensure the tightness of the filtration chamber 3 in the assembled condition.

The four operative configurations introduced above are described below with reference to the specific FIGS. 12, 13, 14 and 15. These configurations correspond to the different possible operating modes of the device of the present invention. As illustrated, the device 1 is configured to operate selectively in one of the operative configurations, according to installation requirements.

The first operative configuration is shown in FIG. 12; in this configuration:
the first inlet/outlet opening 10 is intended to be set into communication with a line coming from a plumbing and heating system, particularly a heating water return line from a system of heating elements (for example heaters or radiators), so as to receive a flow of water to be subjected to filtration;
the second inlet/outlet opening 20 is intended to be set into communication with a line directed to a boiler of the plumbing and heating system, so as to send thereto the flow of water following filtration;
the third inlet/outlet opening 30 is intercepted by the closure element 4;
the flow-directing insert 70 is in the first position for use;
via the second side 77 of the insert, and in particular the separation portion 78 of the second side, and via the outside of the dividing wall 21, the flow of fluid entering the first opening 10 is conveyed directly through the passage section 73 of the insert and from there to the second portion 9 of the filtration chamber 3 inside the mechanical filter 41, where the fluid is filtered by the magnetic filter 50;
the fluid flows out, through the mechanical filter 41, from the second portion 9 of the filtration chamber and passes into the first portion 8 of the filtration chamber, and from there it is conveyed through the first side 74 of the insert towards the second opening 20, the fluid not being able to pass through the passage section again because of the partition of the first side of the insert and the diverting portion 22 of the dividing wall.

The second operative configuration is shown in FIG. 13; in this configuration:
the first inlet/outlet opening 10 is intended to be set into communication with a line coming from a plumbing and heating system, particularly a heating water return line from a system of heating elements (for example heaters or radiators), so as to receive a flow of water to be subjected to filtration;
the second inlet/outlet opening (20) is intercepted by the closure element 4;
the third inlet/outlet opening 30 is intended to be set into communication with a line directed to a boiler of the plumbing and heating system, so as to send thereto the flow of water following filtration;
the flow-directing insert 70 is in the first position for use;
via the second side 77 of the insert, and in particular the separation portion 78 of the second side, and via the outside of the dividing wall 21, the flow of fluid entering the first opening 10 is conveyed directly through the passage section 73 of the insert and from there to the second portion 9 of the filtration chamber 3 inside the mechanical filter 41, where the fluid is filtered by the magnetic filter 50;
the fluid flows out, through the mechanical filter 41, from the second portion 9 of the filtration chamber and passes into the first portion 8 of the filtration chamber, and from there it is conveyed through the first side 74 of the insert towards the third opening 30, the fluid not being able to pass through the passage section 73 again because of the partition 76 of the first side 74 of the insert 70 and the diverting portion 22 of the dividing wall 21.

The third operative configuration is shown in FIG. 14; in this configuration:
the third inlet/outlet opening 30 is intended to be set into communication with a line coming from a plumbing and heating system, particularly a heating water return line from a system of heating elements (for example heaters or radiators), so as to receive a flow of water to be subjected to filtration;
the second inlet/outlet opening 20 is intercepted by the closure element 4;
the first inlet/outlet opening 10 is intended to be set into communication with a line directed to a boiler of the plumbing and heating system, so as to send thereto the flow of water following filtration;
the flow-directing insert 70 is in the second position for use;
via the second side 77 of the insert, and in particular the separation portion 78 of the second side, the flow of fluid entering the third opening 30 is conveyed directly through the passage section 73 of the insert and from there to the second portion 9 of the filtration chamber 3 inside the mechanical filter 41, where the fluid is filtered by the magnetic filter 50;
the fluid flows out, through the mechanical filter 41, from the second portion 9 of the filtration chamber and passes into the first portion 8 of the filtration chamber, and from there it is conveyed through the first side 74 of the insert towards the first opening 10, the fluid not being able to pass through the passage section 73 again because of the raised edge 75 of the first side 74 of the insert and the outside of the dividing wall 21.

The fourth operative configuration is shown in FIG. 15; in this configuration:
the second inlet/outlet opening 20 is intended to be set into communication with a line coming from a plumbing and heating system, particularly a heating water return line from a system of heating elements (for example heaters or radiators), so as to receive a flow of water to be subjected to filtration;
the third inlet/outlet opening 30 is intercepted by the closure element 4;
the first inlet/outlet opening 10 is intended to be set into communication with a line directed to a boiler of the plumbing and heating system, so as to send thereto the flow of water following filtration;
the flow-directing insert 70 is in the second position for use;
via the second side 77 of the insert, and in particular thanks to the separation portion 78 of the second side, the flow of fluid entering the second opening 20 is conveyed directly through the passage section 73 of the insert and from there to the second portion 9 of the filtration chamber 3 inside the mechanical filter 41, where the fluid is filtered by the magnetic filter 50;
the fluid flows out, through the mechanical filter 41, from the second portion 9 of the filtration chamber and passes into the first portion 8 of the filtration chamber, and from there it is conveyed through the first side 74 of the insert towards the first opening 10, the fluid not being able to pass through the passage section 73 again because of the raised edge 75 of the first side 74 of the insert and the outside of the dividing wall 21.

Preferably:
in the first operative configuration, in the second operative configuration and in the third operative configuration the device is positioned vertically, i.e. with the longitudinal axis 2A of the body 2 of the device vertically oriented;
in the fourth operative configuration the device is positioned horizontally, i.e. with the longitudinal axis 2A of the body 2 of the device horizontally oriented.

Observe, in FIGS. 12-15, the arrows indicating the path of the fluid inside the device. In particular:
in the first configuration (FIG. 12) the fluid enters from the first opening 10, flows down into the mechanical filter, is magnetically filtered, passes radially outside the mechanical filter (and is mechanically filtered) and flows back up until exiting from the second opening 20 (the third one is closed); the impurities and residue from the mechanical filtration remain in the second portion of the filtration chamber;
in the second configuration (FIG. 13) the fluid enters from the first opening 10, flows down into the mechanical filter, is magnetically filtered, passes radially outside the mechanical filter (and is mechanically filtered) and flows back up until exiting from the third opening (the second one is closed); the impurities and residue from the mechanical filtration remain in the second portion of the filtration chamber. If the boiler is situated above the device, it is possible to connect an angular coupling (90°) to the outside of the third opening in order to go up towards the boiler.
in the third configuration (FIG. 14) the fluid enters from the third opening 30, flows down into the mechanical filter, is magnetically filtered, passes radially outside the mechanical filter (and is mechanically filtered) and flows back up until exiting from the first opening (the second one is closed); the impurities and residue from the mechanical filtration remain in the second portion of the filtration chamber. If the boiler is situated above the device, it is possible to connect an angular coupling (90°) to the outside of the first opening in order to go up towards the boiler.
in the fourth configuration (FIG. 15) the fluid enters from the second opening 20, passes horizontally directly into the mechanical filter, is magnetically filtered, passes to the outside of the mechanical filter (and is mechanically filtered) and flows back up until exiting from the first opening (the third one is closed); the impurities and residue from the mechanical filtration remain in the second portion of the filtration chamber.

Essentially, in the third configuration the path of the fluid is opposite that of the second configuration, whereas in the fourth configuration the path of the fluid is opposite that of the first configuration.

It should be noted that in all four operative configurations, as represented, the opening that acts as an inlet for the fluid is horizontal, since it is intended to be connected to the return line from the system, which usually comes out of a wall under the boiler. In any case, the first, second and third configurations can also operate horizontally, and the fourth can also operate vertically. In this case it is possible to use suitable couplings, of a known type, to make the water connections between the openings acting as an inlet and outlet of the device and the pipes of the system to which they are to be connected.

It should be noted, furthermore, that the paths of the fluid inside the device, in the four configurations, are obligatory thanks to the flow-directing insert and thanks to the structure and positioning of the elements inside the filtration chamber.

In a possible alternative embodiment, not shown, the first inlet/outlet opening 10 and the third inlet/outlet opening 30 are not aligned with each other, that is, the respective central axes 10A and 30A of the first inlet/outlet opening 10 and of the third inlet/outlet opening 30 do not coincide with each other, but are rather offset. This means that the first inlet/outlet opening 10 and the third inlet/outlet opening 30 are positioned, on the external lateral surface 6 of the body 2, at different heights with respect to the second opening 20 along the longitudinal axis. This makes it possible to have two different longitudinal distances, or distances between centres, between the first opening 10 and the second opening 20 and between the third opening 30 and the second opening 20. In this manner it is possible, advantageously, to select which opening to use as an inlet or as an outlet, either the first opening 10 or the third opening 30, simply by rotating the entire body of the device by 180°.

This can be useful based on the position of the return pipe of the system (to which the device inlet is to be connected) and of the pipe leading back into the boiler (to which the device outlet is to be connected), in particular when operating in the fourth configuration. In such a case, for example, based on the distance of the pipe delivering into the boiler from the wall of installation, it may be useful to select either the first or the third inlet opening as the fluid outlet of the device.

In general, irrespective of the operative configuration selected, the device 1 is usually directly supported by the two lines of the system on which it is installed (or on which the openings acting as inlet and outlet are installed).

The method for filtering a fluid circulating in a plumbing and heating system according to the present invention corresponds to the operating mode of the device 1. Essentially, the method comprises:
arranging a device 1 according to what has been described;
identifying a line coming from the plumbing and heating system, particularly a heating water return line from a system of heating elements, carrying a flow of water to be subjected to filtration;
identifying a line directed to a boiler of the plumbing and heating system, this line carrying a flow of water that has undergone filtration;
operating the device selectively in one of the aforesaid operative configurations.

The invention thus conceived is susceptible of numerous modifications and variants, all falling within the scope of the inventive concept, and the components mentioned may be replaced by other technically equivalent elements.

The invention achieves important advantages. First of all, as emerges clearly from the above description, the invention enables at least some of the drawbacks of the prior art to be overcome.

The device of the present invention enables an effective filtration of a fluid circulating in a plumbing and heating system, and achieving it in every operative configuration. In particular, irrespective of which opening acts as an inlet and which as an outlet, the filtration of the fluid is always optimal. In fact, as amply explained above and illustrated in FIGS. 12-15, in every operative configuration the entire flow of fluid is effectively subjected both to mechanical filtration and to magnetic filtration, without any portion of fluid passing through the device without being completely filtered, as occurs, by contrast, in the solutions of a known type. Therefore, the device of the present invention combines versatility of use, as three inlet/outlet openings are available, and the possibility of deciding which one will act as an inlet for the fluid and which one as an outlet, with maximum efficiency in terms of filtration in every operative configuration.

This allows the device to be adapted to a large number and different types of boilers or other components of a heating system and to be able to be installed even in very limited spaces, while at the same time effectively performing the required filtering operations.

In short, the device of the present invention is capable of operating with consistent high performances irrespective of the mode of installation inside a plumbing and heating system

This is made possible, in particular, thanks to the flow-directing insert, which enables the fluid to be directed in such a manner that it always (i.e. in every operative configuration) flows first inside the mechanical filter (where the magnetic filter is also present) and then, after passing through it, outside of it: this makes the filtration always optimal, overcoming the problems of the prior art.

The path of the fluid in the filtration chamber, always first through the second portion and then through the first one, i.e. always according to an inside-outside scheme with respect to the filtering members, makes it possible to always obtain an effective double filtration.

The two sides of the flow-directing insert are in fact designed to manage, with a single component, four different configurations: once the inlet opening and the outlet opening have been selected (and the remaining opening has been closed), it is sufficient to position the insert in the first or second position for use (by simply rotating the same) and the device will be ready to operate.

Furthermore, the device of the present invention is characterised by high operating reliability and a lower predisposition to faults and malfunctions and it can be assembled, disassembled, cleaned and maintained in a simple and rapid manner.

Finally, the device of the present invention is characterised by a competitive cost and a simple, rational structure.

1. A device (1) for filtering a fluid circulating in a plumbing and heating system, said device (1) comprising a body (2) of the device which defines therewithin a filtration chamber (3) that is destined to have a fluid to be subjected to filtration pass through it, said body being provided with:
a first inlet/outlet opening (10), which sets said filtration chamber (3) in communication with the outside of the device and that is configured to be associated with a line so as to receive therefrom, or to send thereto, fluid incoming to, or exiting from, said body of the device;
a second inlet/outlet opening (20), which sets said filtration chamber (3) in communication with the outside of the device and that is configured to be associated with a respective line so as to receive therefrom, or to send thereto, fluid incoming to, or exiting from, said body of the device;
a third inlet/outlet, opening (30), which sets said filtration chamber (3) in communication with the outside of the device and that is configured to be associated with a respective line so as to receive therefrom, or to send thereto, fluid incoming to, or exiting from, said body of the device;
the device being configured to operate a passage of fluid through said filtration chamber (3), in a selective manner according to a plurality of operative configurations, from one opening among said first inlet/outlet opening (10), said second inlet/outlet opening (20), and said third inlet/outlet opening (30) to another opening among said first inlet/outlet opening (10), said second inlet/outlet opening (20), and said third inlet/outlet opening (30),
the device further comprising:
filtering members (40) that are at least partially housed inside said filtration chamber (3), or associated with said body (2) of the device, and operatively interposed between said first inlet/outlet opening, said second inlet/outlet opening and said third inlet/outlet opening to carry out filtering of the fluid passimg through the filtration chamber;
a flow-directing insert (70) that is housed inside said filtration chamber (3) and configured to channel the fluid passing through the filtration chamber, in each one of said plurality of operative configurations, so that the fluid passes at least partially through said filtering members (40).

2. The device (1) according to claim 1, wherein said flow-directing insert (70) is configured to operate selectively at least in either:
a first position for use, in which it channels the fluid circulating inside the filtration chamber (3) so as to prevent direct passage of the fluid from the first opening (10) to the second opening (20) or from the first opening (10) to the third opening (30) without passing through the filtering members (40);
or
a second position for use, in which it channels the fluid circulating inside the filtration chamber (3) so as to prevent direct passage of the fluid from the second opening (20) to the first opening (10) or from the third opening (30) to the first opening (10) without passing through the filtering members (40).

3. The device (1) according to claim 1, comprising a closure element (4) that is configured to selectively intercept one opening among said first inlet/outlet opening (10), said second inlet/outlet opening (20), and said third inlet/outlet opening (30), and wherein said plurality of operative configurations comprise at least:
a first operative configuration, in which said first opening (10) receives a flow of fluid incoming to the device, said second opening (20) sends the flow of filtered fluid exiting from the device and said third opening (30) is intercepted by said closure element;
a second operative configuration, in which said first opening (10) receives a flow of fluid incoming to the device, said third opening (30) sends the flow of filtered fluid exiting from the device and said second opening (20) is intercepted by said closure element;
a third operative configuration, in which said third opening (30) receives a flow of fluid incoming to the device, said first opening (10) sends the flow of filtered fluid exiting from the device and said second opening (20) is intercepted by said closure element;
a fourth operative configuration, in which said second opening (20) receives a flow of fluid incoming to the device, said first opening (10) sends the flow of filtered fluid exiting from the device and said third opening (30) is intercepted by said closure element.

4. The device (1) according to claim 1, wherein said flow-directing insert (70) is configured to be selectively positioned:
in said first position for use, when the device is operating in said first operative configuration or in said second operative configuration;
in said second position for use, when the device is operating in said third operative configuration or in said fourth operative configuration,
and/or wherein the flow-directing insert (70) has a central axis (71), an external wall (72) extending about said central axis and a passage section (73) inside the external wall and perpendicular to the central axis, the insert (70) having two opposite sides (74, 77) with respect to the central axis, wherein:
a first side (74) is provided, on the external wall (72), with an edge (75) that is raised with respect to the passage section (73), and a partition (76) that intercepts said passage section (73);
a second side (77) lacks a raised edge on the external wall and it lacks a partition on the passage section, thus enabling the passage of fluid through the passage section, and it is provided with a separation portion (78) emerging radially from the external wall (72), away from the central axis (71), and substantially aligned with the passage section (73),
and/or wherein the insert (70) is structured in such a manner that:
the second side (77) enables the passage of fluid, coining from the outside of the insert, through the passage section (73), along a first direction along said central axis (71);
the first side (74) obstructs the passage of fluid, coming from the outside of the insert, through the passage section (73), and determines a process of directing it along a second direction along said central axis (71), opposite said first direction.

5. The device (1) according to claim 1, wherein said first side (74) and said second side (77) constitute two halves of said insert (70) which face each other and are connected along a dividing plane (79) in which the central axis (71) of the insert lies, and wherein the insert (70) is symmetric with respect to a plane of symmetry in which the central axis of the insert lies, and perpendicular to said dividing plane, and/or wherein:
in said first position for use, the insert (70) is positioned in such a manner that the first side (74) thereof faces the third inlet/outlet opening (30) and the second side (77) thereof faces the first inlet/outlet opening (10);
in said second position for use, the insert (70) is positioned in such a manner that the first side (74) thereof faces the first inlet/outlet opening (10) and the second side (77) thereof faces the third inlet/outlet opening (30).

6. The device (1) according to claim 1, wherein the body (2) of the device has a substantially cylindrical shape and it has a longitudinal axis (2A), an upper surface (5), an external lateral surface (6) and a lower surface (7), and wherein the first inlet/outlet opening (10) and the third inlet/outlet opening (30) are located on the external lateral surface (6) of the body of the device and on opposite sides with respect to the filtration chamber (3), and wherein the second inlet/outlet opening (20) is located on the upper surface (5) of the body of the device, and wherein the first inlet/outlet opening (10), the second inlet/outlet opening (20) and the third inlet/outlet opening (30) have a circular section and each one of said openings (10, 20, 30) has a respective central axis, and/or wherein the central axis of the second inlet/outlet opening (20) coincides with the longitudinal axis (2A) of the body (2) of the device, and/or wherein the central axis (71) of the insert (70) coincides with the longitudinal axis (2A) of the body (2) of the device and with the respective central axis of the second inlet/outlet opening (20).

7. The device (1) according to claim 1, wherein the flow-directing insert (70) is located inside the filtration chamber (3) in such a manner as to surround the second inlet/outlet opening (20), and wherein the filtration chamber (3) is delimited laterally by a lateral surface (3A), above by a top surface (3B) and below by a bottom surface (3C) of the body (2) of the device, and/or wherein the second inlet/outlet opening (20) is provided with a dividing wall (21) extending inside the filtration chamber (3) and located between the longitudinal axis (2A) of the body of the device and the first inlet/outlet opening (10), and/or wherein said dividing wall (21) extends, starting from the second inlet/outlet opening (20), inside the filtration chamber (3) along a direction parallel to the longitudinal axis (2A) of the body of the device and substantially to a height (Q) coinciding with the dimensions of the first inlet/outlet opening (10) on the external lateral surface (6) of the body (2) of the device, and/or wherein the dividing wall (21) ends below with a portion for diverting (22) the fluid and that extends towards the longitudinal axis (2A) of the body (2) of the device.

8. The device (1) according to claim 1, wherein the insert (70) is located, inside the filtration chamber (3), in such a manner that its external wall (72) externally surrounds the diverting portion (22) of the dividing wall (21), and/or wherein the diverting portion (22) of the dividing wall (21) is complementarily shaped with respect to the partition (76) of the first side (74) of the insert (70), and/or wherein the positioning of the insert (70) and the diverting portion (22) of the dividing wall (21) with respect to each other is such as to determine that:
when the insert (70) is selectively set into said first position for use, the first side (74) of the insert proves to be on the side opposite the diverting portion (22) with respect to the longitudinal axis (2A) of the body, and facing it, so that the partition (76) and the diverting portion (22) completely intercept the passage section (73) of the insert (70), preventing the passage of fluid through the passage section;
when the insert (70) is selectively set into said second position for use, the first side (74) of the insert is found on the same side as the diverting portion (22), with respect to the longitudinal axis (2A) of the body, and externally embraces the diverting portion (22), whereas the second side (77) of the insert is on the side opposite the diverting portion (22) with respect to the longitudinal axis (2A) of the body, and as the second side (77) lacks a partition, it enables the passage of fluid through the passage section (73),
and/or wherein, when the insert (70) is selectively set into said first position for use, surface continuity is created between the partition (76) and the diverting portion (22) and it is such as to completely intercept the passage section (73) of the insert, and/or wherein passage of the insert (70) between the first position for use and the second position for use takes place by means of a rotation, preferably of 180°, of the insert about its own central axis (71), and/or wherein the partition (76) of the insert (70) substantially has the shape of a portion of a spherical crown, or a portion of a spherical shell, and the diverting portion (22) of the dividing wall (21) substantially has a respective shape of a portion of a spherical crown, or a portion of a spherical shell.

9. The device (1) according to claim 1, wherein the filtering members (40) comprise a mechanical filter (41) configured to separate substances and solid particles present in the fluid to be treated from the fluid itself in which they are suspended, the mechanical filler (41) having a structure provided with a plurality of passages (42) that have a given filtering section, so that the passage of the fluid from one internal side (44) of the mechanical filter to an external side (43) of the mechanical filter determines retention, on the internal side (44), of the substances and particles present in the fluid and having dimensions greater than said filtering section, and/or wherein the mechanical filter (41) has a cylindrical shape extending along a central axis (45) between a first end (46) and a second end (47), and it is positioned inside the filtration chamber (3) in such a manner that said central axis (45) coincides with the longitudinal axis (2A) of the body (2) of the device, and/or wherein the mechanical filter (41) has a smaller radial dimension with respect to the radial dimension of the filtration chamber (3), so as to be distanced from the lateral surface (3A) of the chamber (3) and define, inside the chamber, a first chamber portion (8) outside the mechanical filter (41) and a second chamber portion (9) inside the mechanical filter (41), and/or wherein the mechanical filter (41) is positioned axially between the bottom surface (3C) of the body (2) of the device and the flow-directing insert (70), and/or wherein the mechanical filter (41) is positioned in the chamber under the insert (70) so as to be in fluid communication with the three inlet/outlet openings (10, 20, 30), but under them along the longitudinal axis (2A) of the body (2) of the device, in a direction away from the second inlet/outlet opening (20).

10. The device (1) according to claim 1, wherein the filtering members (40) comprise a magnetic filter (50) associated with the body (2) of the device and configured to collect and retain
substances and particles having ferromagnetic properties and that are present in the fluid to be treated, in such a manner as to separate them from the fluid passing through the device, and/or wherein the body (2) of the device comprises a hollow protuberance (51) that emerges axially, in the filtration chamber, from said bottom surface (3C) towards said top surface (3B), said hollow protuberance (51) defining, outside the body (2) of the device, a housing (52) that is elongated in shape, corresponding to the hollow protuberance (51) and accessible from the lower surface (7), and/or wherein the magnetic filter (50) comprises at least one magnetic element (53) that is configured to generate a permanent magnetic field and inserted in said housing (52) of the body (2) in such a manner as to act upon the fluid passing through the filtration chamber (3) and retain the ferromagnetic substances and particles present in the fluid on the surface of said hollow protuberance (51) inside the body of the device, and/or wherein said hollow protuberance (51) emerging from the bottom surface (3C) is entirely contained inside the mechanical filter (41), so that the magnetic filter (50) is positioned inside said second portion (9) of the filtration chamber (3).

11. The device (1) according to claim 1, said device (1) being configured to operate selectively, when in use, in one of the following operative configurations:
a first operative configuration, in which:
the first inlet/outlet opening (10) is destined to be set into communication with a line coming from a plumbing and heating system, particularly a heating water return line from a system of heating elements, so as to receive a flow of water to be subjected to filtration;
the second inlet/outlet opening (20) is destined to be set into communication with a line directed to a boiler of the plumbing and heating system, so as to send thereto the flow of water following filtration;
the third inlet/outlet opening (30) is intercepted by a closure element (4);
the flow-directing insert (70) is in said first position for use;
via the second side (77) of the insert, and via the outside of the dividing wall (21), the flow of fluid incoming to the first opening (10) is conveyed directly through the passage section (73) of the insert and from there to the second portion (9) of the filtration chamber (3) inside the mechanical filter (41), where the fluid is filtered by the magnetic filter (50);
the fluid flows, through the mechanical filter (41), out from the second portion (9) of the filtration chamber, and passes into the first portion (8) of the filtration chamber (3), and from there it is conveyed through the first side (74) of the insert (70) on towards the second opening (20), the fluid not being able to pass through the passage section (73) again because of the partition (76) of the first side (74) of the insert (74) and the diverting portion (22) of the dividing wall (21);
a second operative configuration, in which:
the first inlet/outlet opening (10) is destined to be set into communication with a line coming from a plumbing and heating system, particularly a heating water return line from a system of heating elements, so as to receive a flow of water to be subjected to filtration;
the second inlet/outlet opening (20) is intercepted by a closure element (4);
the third inlet/outlet opening (30) is destined to be set into communication with a line directed to a boiler of the plumbing and heating system, so as to send thereto the flow of water following filtration;
the flow-directing insert (70) is in said first position for use;
via the second side (77) of the insert, and via the outside of the dividing wall (21), the flow of fluid incoming to the first opening (10) is conveyed directly through the passage section (73) of the insert and from there to the second portion (9) of the filtration chamber (3) inside the mechanical filter (41), where the fluid is filtered by the magnetic filter (50);
the fluid flows, through the mechanical filter (41), out from the second portion (9) of the filtration chamber, and passes into the first portion (8) of the filtration chamber (3), and from there it is conveyed through the first side (74) of the insert (70) on towards the third opening (30), the fluid not being able to pass through the passage section (73) again because of the partition (76) of the first side (74) of the insert and the diverting portion (22) of the dividing wall (21);
a third operative configuration, in which:
the third inlet/outlet opening (30) is destined to be set into communication with a line coming from a plumbing and heating system, particularly a heating water return line from a system of heating elements, so as to receive a flow of water to be subjected to filtration;
the second inlet/opening (20) is intercepted by a closure element (4);
the first inlet/outlet opening (10) is destined to be set into communication with a line directed to a boiler of the plumbing and heating system, so as to send thereto the flow of water following filtration;
the flow-directing insert (70) is in said second position for use;
via the second side (77) of the insert, the flow of fluid incoming to the third opening (10) is conveyed directly through the passage section (73) of the insert and from there to the second portion (9) of the filtration chamber (3) inside the mechanical filter (41), where the fluid is filtered by the magnetic filter (50);
the fluid flows, through the mechanical filter (41), out from the second portion (9) of the filtration chamber, and passes into the first portion (8) of the filtration chamber (3), and from there it is conveyed through the first side (74) of the insert (70) on towards the first opening (10), the fluid not being able to pass through the passage section (73) again because of the raised edge (75) of the first side (74) of the insert and the outside of the dividing wall (21);
a fourth operative configuration, in which:
the second inlet/outlet opening (20) is destined to be set into communication with a line coming from a plumbing and heating system, particularly a heating water return line from a system of heating elements, so as to receive a flow of water to be subjected to filtration;
the third inlet/outlet opening (30) is intercepted by a closure element (4);
the first inlet/outlet opening (10) is destined to be set into communication with a line directed to a boiler of the plumbing and heating system, so as to send thereto the flow of water following filtration;
the flow-directing insert (70) is in said second position for use;
via the second side (77) of the insert (70), the flow of fluid incoming to the second opening (20) is conveyed directly through the passage section (73) of the insert and from there to the second portion (9) of the filtration chamber (3) inside the mechanical filter (41), where the fluid is filtered by the magnetic filler (50);
the fluid flows, through the mechanical filter (41), out from the second portion (9) of the filtration chamber, and passes into the first portion (8) of the filtration chamber (3), and from there it is conveyed through the first side (74) of the insert (70) on towards the first opening (10), the fluid not being able to pass through the passage section (73) again because of the raised edge (75) of the first side (74) of the insert and the outside of the dividing wall (21).

12. A method for filtering a fluid circulating in a plumbing and heating system, said method comprising the steps of:
arranging at least one device (1) for filtering a fluid according to claim 1;
identifying a line coming from a plumbing and heating system, particularly a heating water return line from a system of heating elements, carrying a flow of water to be subjected to filtration;
identifying a line directed to a boiler of the plumbing and heating system, this line carrying a flow of water that has undergone filtration to the boiler;
operating the device (1) selectively in one of said operative configurations.
